(19) United States
(12) Patent Application Publication
(10) Pub. No.: US 2020/0404910 A1
(43) Pub. Date: Dec. 31, 2020

(54) HALO ACTIVE AROMATIC SULFONAMIDE ANTIMICROBIAL AND ODOR CONTROL COATINGS

(71) Applicant: Rem Brands, Inc., Walton, KY (US)

(72) Inventors: David Schneider, Union, KY (US); Jonathan Schneider, Walton, KY (US)

(21) Appl. No.: 16/990,471

(22) Filed: Aug. 11, 2020

Related U.S. Application Data
(63) Continuation-in-part of application No. 16/521,212, filed on Jul. 24, 2019.
(60) Provisional application No. 62/703,751, filed on Jul. 26, 2018.

(51) Int. Cl. A01N 41/10; B65F 1/00

(52) U.S. Cl. CPC A01N 41/10; B65F 1/0026

(57) ABSTRACT

Antimicrobial and odor control coating compositions used to form a coating and/or adhesive film include a halo active aromatic sulfonamide compound of Formula (I):

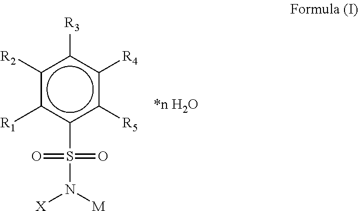

wherein the variables R₁, R₂, R₃, R₄, R₅, X, M and n are disclosed herein. The compositions and processes utilizing the same can be used as a coating or layer to maintain disinfected surfaces with reduced microbial count over extended time periods ranging from multiple days up to several weeks. The compositions and processes utilizing the same can be used to form a coating or layer to maintain odor control on surfaces over extended time periods ranging from multiple days up to several weeks.

### CROSS-REFERENCE TO RELATED APPLICATIONS

This application is a continuation-in-part of U.S. patent application Ser. No. 16/521,212, filed on Jul. 24, 2019, which claims priority to U.S. Provisional Patent Application Ser. No. 62/703,751, filed Jul. 26, 2018, which are incorporated in their entireties by reference herein.

### BACKGROUND

The present disclosure relates to antimicrobial and odor-controlling coating compositions comprising a halo active aromatic sulfonamide compound, and processes utilizing the same, which can provide demand-release antimicrobial action as well as odor reducing properties. The present disclosure also relates to adhesive compositions comprising a halo active aromatic sulfonamide compound, and processes utilizing the same. Further, articles comprising such antimicrobial and odor-controlling coating and/or adhesive compositions having a halo active aromatic sulfonamide compounds are disclosed. The coating and/or adhesive compositions and associated processes find particular usefulness in settings and environments where exposure to bacteria and other microorganisms are prevalent and odor control is desired.

Normal efficacy testing for disinfectants, sterilants, and sanitizers measure performance after a 30-second to 10-minute kill time. These protocols are mandated by various agencies (EPA, AOAC, etc.) to qualify a formulation for registration to claim particular kill performance. However, it is known that products such as bleach, hydrogen peroxide, or peracetic acid are essentially ineffective after they have dried on the surface they are applied to, and have almost no residual kill performance of microorganisms. It would be desirable to provide coatings and adhesives that have extended killing performance and odor-controlling properties over longer periods of time.

### BRIEF DESCRIPTION

It has been found that certain halo active aromatic sulfonamide compositions, and processes using the same, can provide extended microorganism killing performance on various surfaces to which they are applied. These compositions are particularly effective in coating and adhesive applications. In certain circumstances, such residual kill performance can extend for up to one week (seven days, 168 hours), or even two weeks (14 days, 336 hours) or more. In addition, the halo active aromatic sulfonamide compositions are not contact sensitive and/or irritating to the skin. The coatings can provide adhesion properties; protect the active ingredient for a lengthened period of time; and control the release of the active ingredient. Slow, medium, or long release of the active ingredient provides the added benefit of controlling the speed of kill performance and odor neutralization.

These and other non-limiting features or characteristics of the present disclosure will be further described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1A is a cross-sectional view of a portion of a first substrate having a coating film formed from a coating composition in accordance with one aspect of the present disclosure. Here, the coating film is a single-layer film.

FIG. 1B is a cross-sectional view of a portion of a second substrate having a coating film formed from a coating composition in accordance with a second aspect of the present disclosure. Here, the coating film is part of a multi-layer film on the substrate, and is the outermost or external layer of the multi-layer film.

FIG. 1C is a cross-sectional view of a portion of a third substrate having a coating film formed from a coating composition in accordance with a third aspect of the present disclosure. Here, the coating film is part of a multi-layer film on the substrate, and is an internal layer of the multi-layer film (i.e. not the outermost or external layer).

FIG. 2A is a perspective view of a conventional trash bag on which a dry disinfectant and/or odor-eliminating coating can be formed.

FIG. 2B is a cross-sectional view of a sidewall of the trash bag of FIG. 2A.

FIG. 3 is a flowchart illustrating a method of treating a substrate with a coating composition in order to form a coating film in accordance with one aspect of the present disclosure.

FIG. 4 is a cross-sectional view of a portion of two substrates having a coating film formed from a coating composition in accordance with a third aspect of the present disclosure, wherein the coating composition forms an adhesive film between the two substrates.

FIG. 5 is a perspective view of an article comprising an adhesive film on a carrier substrate.

FIGS. 6A-6D are pictures showing the reaction of an acrylic coating containing the sulfonamide compound with an organic substance. FIG. 6A is at time zero. FIG. 6B is after 30 seconds. FIG. 6C is after 1 minute. FIG. 6D is after 2 minutes.

FIGS. 7A-7F are pictures showing the reaction of a styrene-butadiene coating containing the sulfonamide compound with an organic substance. FIG. 7A is at time zero. FIG. 7B is after 1 minute. FIG. 7C is after 2 minutes. FIG. 7D is after 10 minutes. FIG. 7E is after 20 minutes. FIG. 7F is after 30 minutes.

### DETAILED DESCRIPTION

A more complete understanding of the compositions, coatings, articles, and processes disclosed herein can be obtained by reference to the accompanying drawings. These figures are merely schematic representations based on convenience and the ease of demonstrating the present disclosure, and are, therefore, not intended to indicate relative size and dimensions of the articles or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Halo active aromatic sulfonamide organic compounds have been known to reduce or eliminate odor. Chloramine-T is an example of a sulfonamide organic compound which has been used in many applications. The usefulness of Chloramine-T is predicated on its ability to release an active chloride ion when needed on demand, immediately after which it simultaneously generates an active aromatic sulfo nitrene companion ion. The chlorine atom has a +1 formal charge in a hypochlorite ion, ClO⁻, which is the form taken by the chlorine atom when dissociated from the sulfonamide compound. Reference to the chlorine atom as having a +1 or 1⁻ charge may be used in this application interchangeably because this terminology has no effect on the compound itself or its use.

It has been found in the present disclosure that halo active aromatic sulfonamide organic compounds also have an antimicrobial performance that can extend over long periods of time, particularly in various coating and adhesive forms. This may be useful in various commercial, industrial, governmental, and other institutional settings, including places such as waste-disposal sites, hospitals, nursing homes or long term care facilities, schools, detention facilities, travel hubs (e.g., airports, train stations, etc.), vehicles (e.g., boats, cars, airplanes, etc.), homes, fitness centers (e.g., gyms, weight rooms, etc.), or supermarkets. Whereas common disinfectants such as bleach, hydrogen peroxide, or peracetic acid are typically applied to a surface and then dry/evaporate within minutes, ending their disinfectant ability, it has been found that hydrates of halo active aromatic sulfonamide organic compounds will continue to exhibit disinfectant and odor-controlling ability over long time periods, such as over 24 hours, over 48 hours, over 72 hours, over 168 hours, or even as long as 336 hours (two weeks), or longer. It is believed that these compounds can also maintain such properties for longer periods, such as months or even years, so long as the active aromatic sulfonamide organic compound is present and has not been exhausted or decomposed. For example, the disinfectant and odor-controlling features may be maintained for at least 1 month, at least 2 months, at least 3 months, at least 4 months, at least 5 months, at least 6 months, at least 7 months, at least 8 months, at least 9 months, at least 10 months, at least 11 months, or at least 12 months, or more.

The halo active aromatic sulfonamide organic compounds also have several usage benefits over traditional disinfectants such as bleach or hydrogen peroxide. For example, bleach has a very strong chlorine odor in open air and during cleaning; is rapidly destructive for many surface types; only reduces microbes when wet, and has essentially no residual antimicrobial action once dry; has poor stability in “non-ambient” temperatures and light exposure; and is toxic, a skin and eye irritant, and a skin sensitizer. In contrast, compositions using halo active aromatic sulfonamide organic compounds can have equivalent antimicrobial performance, but also have long term residual antimicrobial action when dried on a surface; offer residual odor elimination when dry; have excellent stability, with a shelf life measured in years; and have extremely low toxicity, are not skin/eye irritating, and are not a sensitizer.

### Definitions

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 to 10” is inclusive of the endpoints, 2 and 10, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

As used herein, the terms “wt %” or “weight percent” denote the amount (i.e., weight) of a component per 100 units of the composition (i.e., 1 wt % of component A based on the weight of the composition is equivalent to 1 gram of A per 100 grams of the composition).

It is expressly contemplated that the disclosure of two or more values also discloses ranges with a combination of any two of such values. For example, the disclosure of the ranges “about 0.1 wt % to about 10 wt %” and “about 0.5 wt % to 5 wt %” should be construed as also disclosing the ranges “about 0.1 wt % to about 0.5 wt %” and “about 5 wt % to about 10 wt %”.

The term “ambient temperature” refers to a temperature of 20° C. to 25° C.

The present disclosure may refer to temperatures for certain process steps. It is noted that these generally refer to the temperature at which the heat source (e.g. furnace) is set, and do not refer to the temperature which must be attained by the material being exposed to the heat.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “alkyl” refers to a radical composed entirely of carbon atoms and hydrogen atoms which is fully saturated. The alkyl radical may be linear, branched, or cyclic, and such radicals may be referred to as linear alkyl, branched alkyl, or cycloalkyl.

The term “aromatic” refers to a radical that has a ring composition containing a delocalized conjugated pi composition with a number of pi-electrons that obeys Hückel's Rule. The ring composition may include heteroatoms (e.g. N, S, Se, Si, O), or may be composed exclusively of carbon and hydrogen. Exemplary aromatic groups include phenyl, thienyl, naphthyl, and biphenyl.

The term “aryl” refers to an aromatic radical composed exclusively of carbon and hydrogen. Exemplary aryl groups include phenyl, naphthyl, and biphenyl.

The term “heteroaryl” refers to an aromatic radical containing at least one heteroatom. Exemplary heteroaryl groups include thienyl. Note that “heteroaryl” is a subset of “aromatic”, and is exclusive of “aryl”.

The term “alkoxy” refers to an alkyl radical which is attached to an oxygen atom, i.e. —O—CnH₂ₙ₊₁, to a molecule containing such a radical.

The term “halogen” refers to fluorine, chlorine, bromine, and iodine.

The term “substituted” refers to at least one hydrogen atom on the named radical being substituted with another functional group, such as halogen, —CN, or —NO₂. Besides the aforementioned functional groups, an aromatic group may also be substituted with alkyl or alkoxy. An exemplary substituted aryl group is methylphenyl.

The term “alkali metal” refers to lithium, sodium, and potassium.

The term “alkaline earth metal” refers to magnesium and calcium.

As used herein, the term “antimicrobial” means an agent that will kill or inhibit the growth of microorganisms, such as, for example, bacteria, viruses, and fungi.

As used herein, the term “disinfect” means to inactivate, kill, or otherwise render non-pathogenic a pathogen, such as, for example, a bacteria, virus, for fungus.

As used herein, the term “killing performance” refers to the ability of a composition to inactivate, kill, or otherwise render non-pathogenic a microorganism, and may be measured as a function of the reduction in viability of a particular microorganism. The term “killing performance” may also have a time/duration dimension (i.e. killing performance at 24 hours, 48 hours, 72 hours, etc.).

The term “film” or “layer” or “coating” refers to a covering upon the surface of an object (also called a substrate). The film or layer or coating may cover the entire surface, or just a portion of the surface.

The term “dry” is used to refer to the film or layer or coating containing so little solvent that it does not flow when in the steady state.

Staphylococcus aureus (i.e. S. aureus) is a gram-positive bacteria commonly found on skin and in the nasopharynx. It can infect any human tissue, invade the body, and cause death. It is a leading cause of bacterial infections and death due to bacterial infections. Antibiotic treatment of S. aureus infection is complicated by widespread drug-resistance (MRSA, VRSA).

Pseudomonas aeruginosa (i.e. P. aeruginosa) is a gram-negative bacteria found throughout the natural and health care environment. It can infect any human tissue, invade the body, and cause death. It is a leading cause of bacterial infections and death in the immunocompromised, especially in cancer and burn patients. Antibiotic treatment of P. aeruginosa infection is complicated by widespread drug-resistance.

Clostridium difficile (i.e. C. difficile) is a spore-forming gram-positive bacteria that is highly prevalent in the environment. It is a common cause of antibiotic-associated diarrhea and may cause life-threatening infections. The spores of C. difficile survive long-term in the environment and contaminate many surfaces in hospital environments. C. difficile is anaerobic, grows only where there is no oxygen, and cannot survive outside the body as a living cell, therefore it forms bacterial endospores. C. difficile endospores are highly resistant to disinfectants and various forms of radiation, and can persist for years on surfaces. Antibiotic treatments for C. difficile infection are complicated by endospore formation in the body, as the dormant endospores are not affected by antibiotics. Effective methods for destroying bacterial endospores need to be developed to limit the infection of new hosts.

Coating Compositions and Coating Films

The coating compositions of the present disclosure, which are used to form a final coating film on a substrate, generally comprise: (A) at least one halo active aromatic sulfonamide compound, as described herein; (B) a at least a primary coating additive for forming the film; and (C) a solvent, such as water. The coating compositions can also include (D) a buffering agent; (E) a surfactant; (F) a tracer fragrance; (G) an UV indicator; and/or (H) secondary additives, such as pigments or other antimicrobial and/or odor-controlling compounds, in any combination. In particular embodiments, one or more of these additional ingredients (D)-(H) is present in the coating composition. Additionally, the coating compositions may be evaporative, meaning that parts of the composition evaporate to leave a coating film (i.e. a dry-coated film) that can maintain a suitable killing performance and/or odor control for extended periods of time.

The halo active aromatic sulfonamide compound(s) (A) used in the coating compositions of the present disclosure may have the structure of base Formula (I):

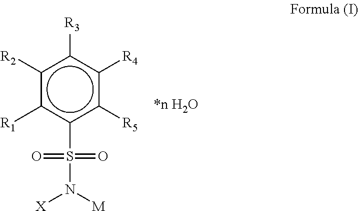

wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;

R′ is hydrogen, an alkali metal, an alkaline earth metal, substituted C₁-C₁₈ alkyl, or unsubstituted C₁-C₁₈ alkyl; and

R″ is hydrogen or substituted or unsubstituted C₁-C₁₈ alkyl, where the two R″ groups in CON(R″)₂ and N(R″)₂ may be independently selected;

X is halogen;

M is an alkali or alkaline earth metal; and

n is the number of water molecules per molecule of the sulfonamide compound.

The term “aromatic”, as used herein, does not refer to a smell detected by the nose.

Generally, M is sodium or potassium. X is generally chlorine, bromine, fluorine, or iodine, and in particular embodiments is chlorine. Compounds of Formula (I) may or may not be hydrated, as indicated by the variable n. In particular embodiments, the compounds of Formula (I) are a trihydrate (i.e., n=3) or a hexahydrate (i.e. n=6). In other embodiments, the compound is in a solid form, such as a powder.

When the phenyl and/or alkyl group is substituted, one or more hydrogen atoms may be independently replaced with hydroxyl or halogen.

In particular embodiments of Formula (I), R₃ is methyl, COOH, or COOK; R₁, R₂, R₄, and R₅ are independently selected from hydrogen, COOH, COOK, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M₁ is an alkali or alkaline earth metal; and n is the number of water molecules per molecule of the sulfonamide compound.

In further embodiments, R₃ is methyl, COOH, or COOK; R₁, R₂, R₄, and R₅ are independently selected from hydrogen, COOH, COOK, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M is an alkali or alkaline earth metal; n is the number of water molecules per molecule of the sulfonamide compound; and at least one of R₁, R₂, R₄, and R₅ is not hydrogen.

In yet other embodiments of Formula (I), R₃ is selected from COOH, COOK, COOR′, CON(R″)₂, CN, NO₂, halogen, and substituted or unsubstituted C₂-Cis alkyl; R₁, R₂, R₄, and R₅ are independently selected from hydrogen, COOH, COOK, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound.

In still other embodiments of Formula (I), R₁, R₂, R₃, R₄, and R₅ are independently selected from hydrogen, COOH, COOK, NO₂, halogen, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound.

In yet other embodiments of Formula (I), R₂ and R₄ are identical to each other; and R₁, R₃, and R₅ are hydrogen.

In yet other embodiments of Formula (I), R₂ and R₄ are hydrogen; and R₁, R₃, and R₅ are identical to each other.

In more specific embodiments of Formula (I), R₃ is selected from COOH, COOM₁, COOR′, and CON(R″)₂. Most desirably, R₃ is COOH or COOM₁, while R₁, R₂, R₄, and R₅ are hydrogen.

In other embodiments of Formula (I), R₁, R₂, R₃, R₄, and R₅ are independently selected from hydrogen, COOH, COOM₁, COOR′, CON(R″)₂, NO₂, halogen, N(R″)₂, substituted or unsubstituted C₁-C₁₈ alkyl, and substituted or unsubstituted aromatic; wherein at least one of R₁, R₂, R₃, R₄, and R₅ is not hydrogen; X is halogen; M is an alkali or alkaline earth metal; and n is the number of water molecules per molecule of the sulfonamide compound.

In still other embodiments of Formula (I), R₃ is COOH or COOM₁; R₁, R₂, R₄, and R₅ are independently selected from hydrogen, NO₂, halogen, N(R″)₂, substituted or unsubstituted C₁-C₁₈ alkyl, and substituted or unsubstituted aromatic; X is halogen; M is an alkali or alkaline earth metal; and n is the number of water molecules per molecule of the sulfonamide compound. In further specific embodiments, at least one of R₁, R₂, R₄, and R₅ is not hydrogen.

In some embodiments of Formula (I), at least one of R₁, R₂, R₃, R₄, or R₅ are not hydrogen. In more specific embodiments of Formula (I), at least two of R₁, R₂, R₃, R₄, or R₅ are not hydrogen. In other words, the benzene ring contains the sulfonamide substituent and an additional one or two other substituents.

In other embodiments of Formula (I), the halo active aromatic sulfonamide compound has the structure of Formula (II):

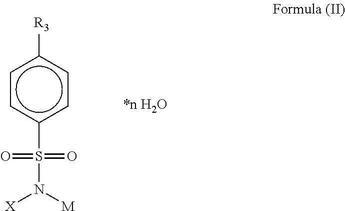

wherein R₃ is COOR′; R′ is hydrogen, an alkali metal, an alkaline earth metal, substituted C₁-C₁₈ alkyl, unsubstituted C₁-C₁₈ alkyl, substituted aromatic, or unsubstituted aromatic; X is halogen; M is an alkali or alkaline earth metal; and n is the number of water molecules per molecule of the sulfonamide compound. The N-chloro-4-carboxybenzenesulfonamide compound of Formula (II) is also referred to herein as BENZ. BENZ exhibits a lower chlorine smell than chloramine-T or chloramine-B. When BENZ is combined with at least one fragrance, there is no detectable chlorine smell for most humans.

Two particular sulfonamide compounds contemplated for use are N-chloro-p-toluenesulfonam ide (i.e. chloramine-T) and N-chloro-4-carboxybenzenesulfonamide (i.e. BENZ). These two compounds are shown below as Formulas (III) and (IV):

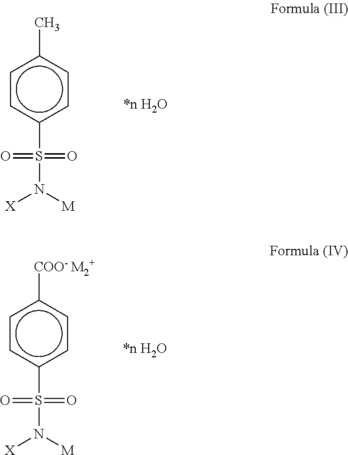

wherein M₂ is hydrogen, an alkali metal, or an alkali earth metal; X is halogen, M is independently an alkali or alkaline earth metal; and n is the number of water molecules per molecule of each sulfonamide compound. Desirably, M₂ is hydrogen, sodium, or potassium.

In other particular embodiments, one or more of R₁, R₂, R₃, R₄, and R₅ are substituted with —COOR′ (and the others are hydrogen). In this regard, it is believed that when the halo active aromatic sulfonamide compound has two or more ionic charges, that the compound has higher antimicrobial and odor control performance. The antimicrobial performance of these compounds of Formula (I) was not expected, because sulfonamide groups having a halogen atom bonded to the nitrogen atom are not present in molecules having known antimicrobial or odor control properties.

The halo active aromatic sulfonamide compounds of base Formula (I) are stable and do not decompose in aqueous solution, allowing the coating composition to have a long shelf life. The compounds of Formula (I) are also very soluble in water, low in toxicity, and have minimal bleach odor.

The halo active aromatic sulfonamide compound (A) may be present in the coating composition in the amount of about 0.0001 wt % to about 40 wt %, based on the weight of the coating composition. In further embodiments, the halo active aromatic sulfonamide compound may be present in the coating composition in the amount of about 0.0001 wt % to about 0.001 wt %, or about 0.001 wt % to about 0.002 wt %, or about 0.002 wt % to about 0.003 wt %, or about 0.003 wt % to about 0.004 wt %, or about 0.004 wt % to about 0.005 wt %, or about 0.005 wt % to about 0.006 wt %, or about 0.006 wt % to about 0.007 wt %, or about 0.007 wt % to about 0.008 wt %, or about 0.008 wt % to about 0.009 wt %, or about 0.009 wt % to about 0.01 wt %, or about 0.01 wt % to about 0.02 wt %, or about 0.02 wt % to about 0.03 wt %, or about 0.03 wt % to about 0.04 wt %, or about 0.04 wt % to about 0.05 wt %, or about 0.05 wt % to about 0.06 wt %, or about 0.06 wt % to about 0.07 wt %, or about 0.07 wt % to about 0.08 wt %, or about 0.08 wt % to about 0.09 wt %, or about 0.09 wt % to about 0.1 wt %, or about 0.1 wt % to about 0.2 wt %, or about 0.2 wt % to about 0.3 wt %, or about 0.3 wt % to about 0.4 wt %, or about 0.4 wt % to about 0.5 wt %, or about 0.5 wt % to about 0.6 wt %, or about 0.6 wt % to about 0.7 wt %, or about 0.7 wt % to about 0.8 wt %, or about 0.8 wt % to about 0.9 wt %, or about 0.9 wt % to about 1 wt %, or about 1 wt % to about 5 wt %, or about 5 wt % to about 10 wt %, or about 10 wt % to about 35 wt %, or about 10 wt % to about 20 wt %, or about 20 wt % to about 30 wt %, or about 30 wt % to about 40 wt %, or any combination of endpoints thereof, based on the weight of the coating composition.

In some embodiments, the halo active aromatic sulfonamide compound may be present in the final coating film (i.e., after application of the coating composition and/or treating the substrate with the coating composition) in the amount of about 0.0001 wt % to about 99.99 wt %, based on the weight of the formed coating film, including from about 0.0001 wt % to about 0.001 wt %, from about 0.001 wt % to about 0.01 wt %, from about 0.01 wt % to about 0.1 wt %, from about 0.1 wt % to about 1 wt %, from about 1 wt % to about 5 wt %, from about 5 wt % to about 10 wt %, from about 10 wt % to about 20 wt %, from about 20 wt % to about 30 wt %, from about 30 wt % to about 40 wt %, from about 40 wt % to about 99.5 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, from about 85 wt % to about 95 wt %, from about 90 wt % to about 99.99 wt %, or any combination of endpoints thereof, based on the weight of the coating film. Depending on the application, this may translate to a weight of about 30 milligrams (mg) to about 75 mg of the halo active aromatic sulfonamide compound being present in the coating film on the surface of the substrate.

The coating compositions of the present disclosure further include at least one primary coating additive (B). As used in the present disclosure, a coating additive is a compound, typically a polymer or copolymer, which promotes the formation of a coating film on a substrate. That is, the coating additive is a film-forming agent that solidifies as a result of physical and/or chemical processes. In certain embodiments, the primary coating additive may also be an adhesive resin, i.e. a material that is used to stick two substrates together. The primary coating additive may be water soluble and/or soluble in other solvents, such as an alcohol, at certain temperatures. For example, the primary coating additive may be a thermoplastic polymer or a thermosetting polymer.

In particular embodiments, the primary coating additive may be at least one of a polyolefin, a polyol, a polyvinyl compound, a polyacrylic resin, and a cellulose or cellulose derivative. In specific embodiments, the polyolefin may be, for example, polyethylene, polypropylene, polyisoprene, chlorinated rubber, cyclo rubber, polybutadiene, styrene butadiene copolymer, or acrylonitrile-butadiene-styrene. In further embodiments, the polyvinyl compound may be, for example, polyvinyl chloride, polyvinyl ester, polyvinyl ether, a polyvinyl chloride copolymer, polyvinyl alcohol, or polyvinyl acetate. In still further embodiments, the polyacrylic resin may be, for example, an acrylate, an methacrylate, or a cyanoacrylate. In further embodiments, the primary coating additive may be a cellulose or cellulose derivative, such as, for example, cellulose, methylcellulose, hydroxypropyl methylcellulose (HPMC), hydroxypropyl cellulose, ethyl cellulose. In preferred embodiments, the primary coating additive is selected from a group consisting of: styrene butadiene, acrylic, vinyl acetate, and hydroxypropyl methylcellulose (HPMC).

In embodiments wherein the coating composition is an adhesive composition, the primary coating additive (i.e., adhesive resin), can be at least one of the compounds discussed above, or may additionally be at least one of: an epoxy; a polyurethane; a cyanoacrylate; an acrylate or modified acrylic; a phenolic; a polyvinyl alcohol; an ethylene vinyl acetate; a polyamide; a styrene block copolymer; a polyolefin; and/or a polysulfone. In specific embodiments, the primary coating additive which acts as an adhesive resin may be at least one of: polyester; urethane; epoxy; silicone; acrylate; polysulfide; polyimide; EVA (ethylene-vinyl acetate); phenol; polybenzimidazole; polyquinoxazoline; polyphenylquinoxazoline; bismaleimide; polyvinylalcohol; cyanoacrylate; polyene; polythiol; SBC (styrene block copolymer); fibrin; gelatin; SBR (styrene-butadiene rubber); rubber latex; nitrile-phenol; and vinyl phenol.

The primary coating additive may also be a carbon-based material, such as graphite, graphene, or carbon nanotubes, or carbides. Also contemplated as primary coating additives are waxes, polysaccharides, or oils.

Suitable waxes may be, for example, a natural vegetable wax, natural animal wax, mineral wax and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes may include, for example, Fischer-Tropsch wax, acrylate wax, fatty acid amide wax, silicone wax, polytetrafluoroethylene wax, polyethylene wax, polypropylene wax, and mixtures thereof. The waxes may be functionalized. Examples of groups added to functionalize waxes include amines, amides, imides, esters, quaternary amines, and/or carboxylic acids. For example, the functionalized waxes may be acrylic polymer emulsions, or chlorinated polypropylenes and polyethylenes. Waxes meeting these specifications are commercially available.

Polysaccharides can be used to form coatings. Natural gums, such as gum arabic, comprise a large number of polysaccharides such as agarose; pectins; alginic acid and alginates; carrageenan; and various systems of hydrocolloids. Other polysaccharides can include glucose, xylitol, mannitol, maltitol, and sorbitol, and derivatives thereof such as galactomannan. Other polysaccharides such as gellan gum or xanthan gum are also contemplated.

Oils which may be suitable as coating additives include vegetable oils, castor oil, coconut oil, palm oil, rubber seed oil, flaxseed oil, linseed oil, nut oils, soybean oil, sunflower oil, canola oil, and camelina oil, among others.

In some embodiments, the primary coating additive may be present in the coating composition in the amount of about 0.0001 wt % to about 99.99 wt %, based on the total weight of the coating composition. In further embodiments, the primary coating additive may be present in the amount of about 0.01 wt % to about 25 wt %, or about 0.01 to about 10 wt %, or any combination of endpoints thereof, based on the total weight of the coating composition. In still further embodiments, the primary coating additive may be present in the amount of about 0.01 wt % to about 0.1 wt %, or about 0.1 wt % to about 0.2 wt %, or about 0.2 wt % to about 0.3 wt %, or about 0.3 wt % to about 0.4 wt %, or about 0.4 wt % to about 0.5 wt %, or about 0.5 wt % to about 0.6 wt %, or about 0.6 wt % to about 0.7 wt %, or about 0.7 wt % to about 0.8 wt %, or about 0.8 wt % to about 0.9 wt %, or about 0.9 wt % to about 1.0 wt %, or about 1.0 wt % to about 1.5 wt %, or about 1.5 wt % to about 2.0 wt %, or about 2.0 wt % to about 2.5 wt %, or about 2.5 wt % to about 3.0 wt %, or about 3.0 wt % to about 3.5 wt %, or about 3.5 wt % to about 4.0 wt %, or about 4.0 wt % to about 4.5 wt %, or about 4.5 wt % to about 5.0 wt %, or about 5.0 wt % to about 5.5 wt %, or about 5.5 wt % to about 6.0 wt %, or about 6.0 wt % to about 6.5 wt %, or about 6.5 wt % to about 7.0 wt %, or about 7.0 wt % to about 7.5 wt %, or about 7.5 wt % to about 8.0 wt %, or about 8.0 wt % to about 8.5 wt %, or about 8.5 wt % to about 9.0 wt %, or about 9.0 wt % to about 9.5 wt %, or about 9.5 wt % to about 10.0 wt %, or about 10 wt % to about 15 wt %, or about 15 wt % to about 20 wt %, or about 25 wt %. In specific embodiments, the primary coating additive may be present in the amount of at least 25 wt %, or at least 30 wt %, or at least 40 wt %, or at least 50 wt %, based on the total weight of the coating composition.

In some embodiments, the coating compositions of the present disclosure include one or more primary coating additives (B).

The coating compositions of the present disclosure further include at least one solvent (C). As used herein, the term solvent refers to a liquid comprising one or more components that may be volatile under specific conditions and can dissolve the components of the coating composition. The solvent may also lower the viscosity of the coating composition to make it easier to apply. In certain embodiments, the solvent can include one or more aliphatic hydrocarbon compounds, aromatic hydrocarbon compounds, water, and/or alcohols. As discussed above, the solvent (C) may comprise two or more solvents. In particular embodiments, the at least one solvent (C) includes water. In preferred embodiments, the at least one solvent (C) comprises, consists essentially of, or consists of water.

The solvent generally makes up the remainder or balance of the coating composition after accounting for the active composition (A), primary coating additive (B), and any other ingredients (e.g., (D)-(H)). In specific embodiments, the solvent may be present in the coating composition in the amount of about 20 wt % to about 99.9 wt %, based on the weight of the coating composition, including from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, and from about 90 wt % to about 99.9 wt %, including any combination of endpoints thereof, based on the total weight of the coating composition.

In particular embodiments, after application of the coating composition to a substrate, typically almost all of the solvent is removed, for example via evaporation or curing, to obtain a coating film. Thus, in certain embodiments, the coating film may comprise less than 50 wt % of the solvent, based on the weight of the coating film, including less than 40 wt %, or less than 30 wt %, or less than 20 wt %, or less than 10 wt %, or less than 5 wt %, or less than 1 wt %, or less than 0.1 wt %, based on the weight of the coating film. In particular embodiments, only a residual amount of solvent is present in the coating film. That is, the coating film may be substantially free of solvent.

Additional Additives

A buffering agent (D) may be added to the coating composition in amounts designed to maintain coating composition within a particular pH range. For stability and for optimum performance, the pH of the coating composition should be between about 5 and about 14, though generally the pH should be kept between about 8 and about 14, or between about 6 and about 10, or between about 6.5 and about 9, or between about 7 and about 9, or between about 7 and about 8.5, or between about 8 and about 9. Exemplary buffering agents include sodium bicarbonate, potassium bicarbonate, sodium carbonate, potassium carbonate, acetate buffers (such as sodium acetate), phosphate buffers (such as tri and di sodium phosphate and mixtures thereof, pH blended phosphates, sulfate buffers (such as di and tri sodium sulfate), and mixtures thereof. Particularly preferred buffering agents include sodium bicarbonate and sodium acetate.

The buffering agent (D) can be added up to the limit of solubility in the coating composition. In particular embodiments, the buffering agent (D) may be present in the coating composition in an amount of greater than 0 wt % to about 5 wt %, based on the total weight of the coating composition, including from about 0.1 wt % to about 0.5 wt %, or about 0.5 wt % to about 1 wt %, or about 1 wt % to about 2 wt %, or about 2 wt % to about 3 wt %, or about 3 wt % to about 4 wt %, or about 4 wt % to about 5 wt %, or any combination of endpoints thereof, based on the total weight of the coating composition. In further embodiments, the preferred weight ratio of the sulfonamide compound to the buffering agent is from about 1000:1 to about 1:1, or from about 500:1 to about 2:1, or from about 100:1 to about 2:1, or from about 50:1 to about 1:1, or from about 50:1 to about 2:1, or from about 20:1 to about 2:1.

A surfactant (E), or wetting agent, can also be added to the coating compositions of the present disclosure. The surfactant decreases surface tension, allowing the sulfonamide compound to be spread more widely upon the surface to which it is applied. Both non-ionic and anionic surfactants can be used. However, in some specific embodiments, a surfactant is not used. The surfactant (D) can be present in the coating composition in the amount of about 0.0001 wt % to about 5 wt %.

A tracer fragrance (F) can also be included in the coating composition if desired. The tracer fragrance can be present in the coating composition in the amount of about 0.0001 wt % to about 5 wt %.

The coating compositions of the present disclosure may also include a UV indicator (G) for the purpose of detecting the spread/distribution of the coating composition on the surface, which can aid in deciding whether more of the coating composition needs to be applied. Examples of a UV indicator include UVPW, which is a stilbene derivative with a peak excitation at 365 nm and a peak emission at 450 nm and is commercially available at maxmax.com. The UV indicator (G) may be, for example, an invisible water-soluble powder. The UV indicator (G) may be present in the coating composition in the amount of about 0.0001 wt % to about 5 wt %, based on the total weight of the coating composition, including from about 0.001 wt % to about 0.01 wt %, from about 0.01 wt % to about 0.02 wt %, from about 0.02 wt % to about 0.03 wt %, from about 0.03 wt % to about 0.04 wt %, from about 0.04 wt % to about 0.05 wt %, from about 0.05 wt % to about 0.06 wt %, from about 0.06 wt % to about 0.07 wt %, from about 0.07 wt % to about 0.08 wt %, from about 0.08 wt % to about 0.09 wt %, from about 0.09 wt % to about 0.1 wt %, from about 0.1 wt % to about 0.2 wt %, from about 0.2 wt % to about 0.3 wt %, from about 0.3 wt % to about 0.4 wt %, from about 0.4 wt % to about 0.5 wt %, from about 0.5 wt % to about 0.6 wt %, from about 0.6 wt % to about 0.7 wt %, from about 0.7 wt % to about 0.8 wt %, from about 0.8 wt % to about 0.9 wt %, from about 0.9 wt % to about 1 wt %, from about 1 wt % to about 2 wt %, from about 2 wt % to about 3 wt %, from about 3 wt % to about 4 wt %, and from about 4 wt % to about 5 wt %, or any combination of endpoints thereof. In particular embodiments, the coating composition does not include any UV indicator.

The coating compositions of the present disclosure may further include one or more secondary additives (H), such as pigments, antioxidants, fillers (e.g., metal powder, clays including cat litter, dust, glass fiber, aluminum, aluminum oxide, lead, mica, silica sand, silicon carbide, zinc, titanium dioxide, iron oxides, calcium carbonate, silver, carbon black, graphite, copper, nickel, iron, chromium, molybdenum, tungsten, etc.), thixotropic agents, plasticizers, reinforcing agents, thickeners, antifungal agents, emulsifiers, antimicrobial agents, conductive particles, and the like, and combinations thereof. These secondary additives (H) may be added to the coating compositions in order to improve processability, adhesion, performance, or appearance of the coating composition, or to impart additional desirable properties (e.g., conductivity). In particular embodiments, the secondary additives may include, for example, silane, quat, silane-quat, silver, or other metals. As used herein, the term “quat” refers to quaternary ammonia compounds. The secondary additives may be present in the coating composition in the amount of about 0.0001 wt % to about 5 wt %, based on the total weight of the coating composition. However, in certain embodiments, the coating composition does not include or is substantially free from any secondary additives. The resulting coating film may be clear or opaque, as desired.

In some specific embodiments, the coating composition comprises from about 0.001 wt % to about 40 wt % of the halo active aromatic sulfonamide compound (A); from about 0.0001 to about 99.99 wt % of the primary coating additive (B); from about 0.001 wt % to about 1 wt % of a UV indicator (G); and remainder solvent.

In other specific embodiments, the coating composition comprises from about 10 wt % to about 35 wt % of the halo active aromatic sulfonamide compound (A); from greater than 0 to about 10 wt % of the primary coating additive (B); from greater than 0 to about 5 wt % of a buffering agent (D); and remainder solvent.

In some embodiments, then, the resulting coating film may comprise from about 0.001 wt % to about 99.99 wt % of the halo active aromatic sulfonamide compound (A); from about 0.0001 to about 99.99 wt % of the primary coating additive (B); and from 0 to about 1 wt % of a UV indicator (G). At most 1 wt % of the coating film is solvent.

In other specific embodiments, the resulting coating film may comprise from about 40 wt % to about 99.99 wt % of the halo active aromatic sulfonamide compound (A); from greater than 0 to about 50 wt % of the primary coating additive (B); and from 0 to about 33 wt % of a buffering agent (D). At most 1 wt % of the coating film is solvent.

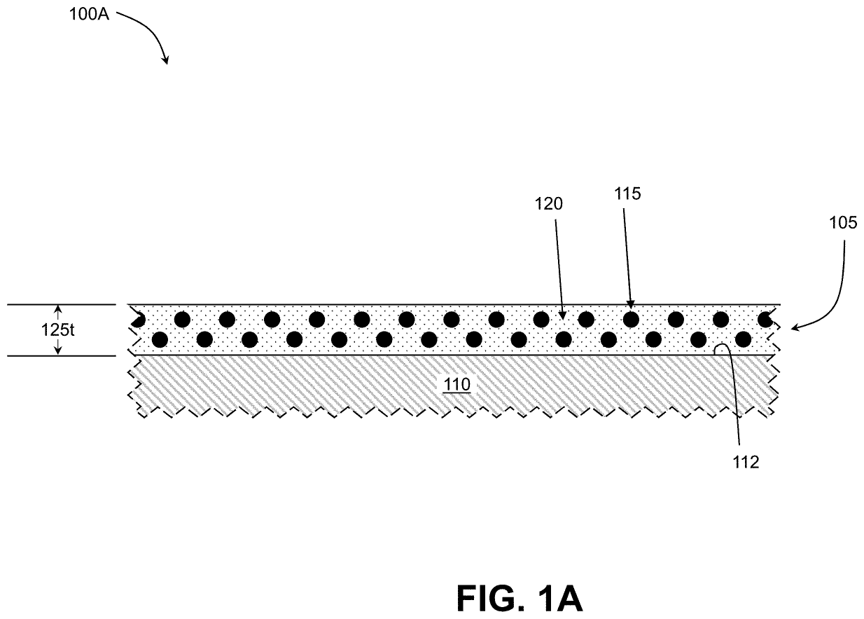

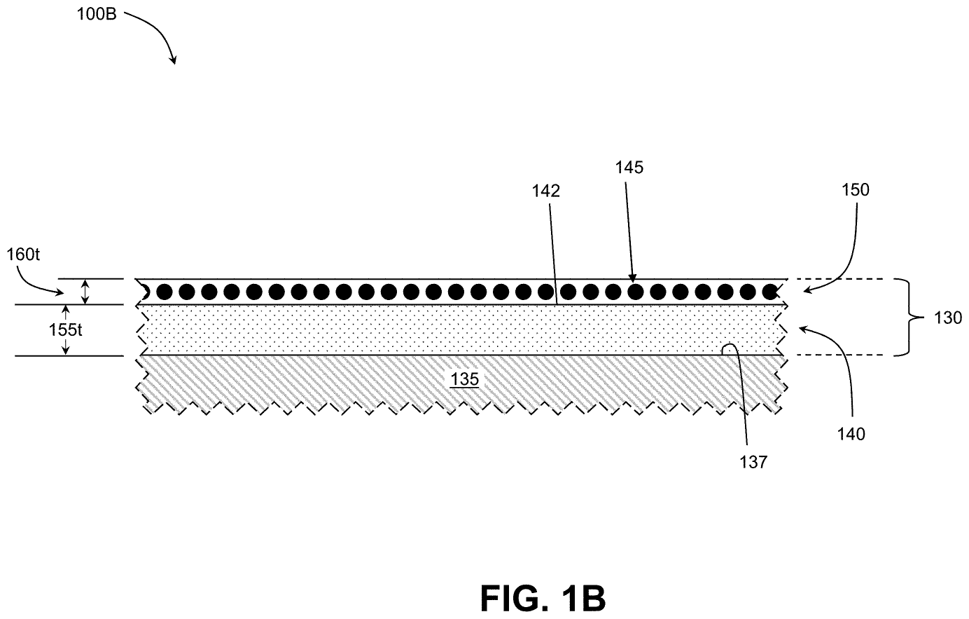

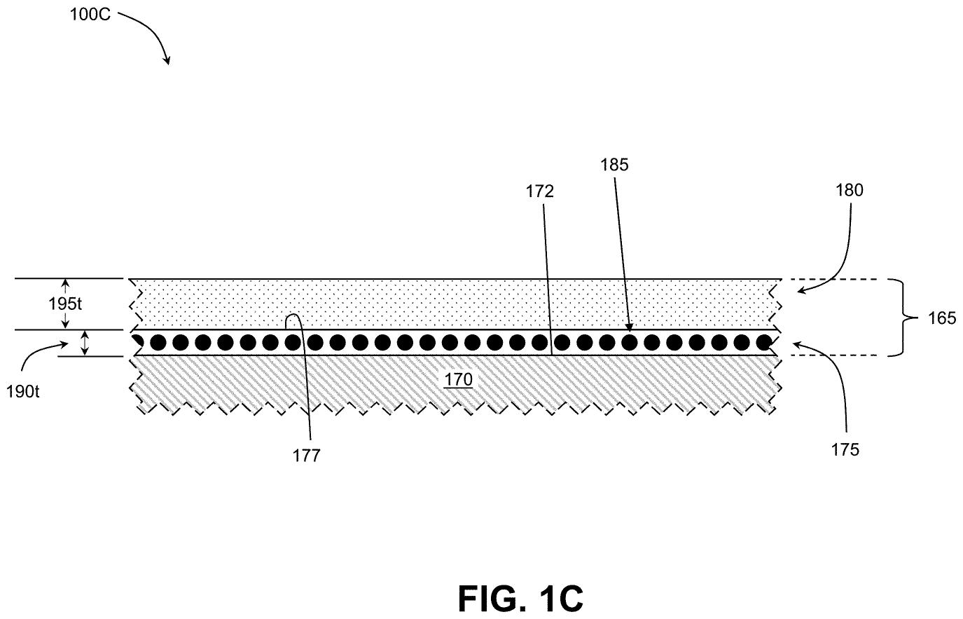

With reference to FIGS. 1A-1C, three exemplary embodiments of a coating film formed on a substrate in accordance with the present disclosure are illustrated.

Turning to FIG. 1A, a portion 100A of a substrate 110 having a coating film 105 formed on at least a portion of a surface 112 of the substrate 110 is illustrated in accordance with one aspect of the present disclosure. As shown, the coating film 105 comprises a single layer formed by applying a coating composition to a surface 112 of the substrate 110. In this particular embodiment, the coating film 105 comprises an amount of halo active aromatic sulfonamide compound 115, which is dispersed throughout a matrix 120 of the coating film 105. Generally, the matrix 120 is formed from the primary coating additive and may include any other additives, such as a buffering agent, as described above. Depending on the coating additive used, the coating film 105 may have a thickness 125t of from about 50 micrometers (μm) to about 5 millimeters (mm), including from about 100 μm to about 200 μm, or from about 200 μm to about 300 μm, or from about 300 μm to about 400 μm, or from about 400 μm to about 500 μm, or from about 500 μm to about 600 μm, or from about 600 μm to about 700 μm, or from about 700 μm to about 800 μm, or from about 800 μm to about 900 μm, or from about 900 μm to about 1 mm, or from about 1 mm to about 2 mm, or from about 2 mm to about 3 mm, or from about 3 mm to about 4 mm, or from about 4 mm to about 5 mm, of up to 1 cm, or any combination of endpoints thereof. If, for example, the coating additive is graphene, a monolayer of graphene may have a thickness of as little as 0.33 nanometers, and so the thickness 125t may be very small as well. Generally, the entire range from 0.33 nm to 1 cm is contemplated, as well as any combination of endpoints mentioned above.

Because the coating film 105 is porous or permeable or semi-permeable, various microorganisms and/or malodorous compounds on the external surface of the substrate 110 (and the coating film 105) can migrate inwards to the internal volume of the coating film containing the halo active aromatic sulfonamide compound 115 and be neutralized. It is also possible for the halo active aromatic sulfonamide compound to migrate to the external surface due to humidity.

Turning to FIG. 1B, a second exemplary embodiment of a coating film 130 formed on a substrate 135 is illustrated. As shown, a portion 100B of a substrate 135 has a multi-layer film 130 formed upon a surface 137 of the substrate 135 including a first layer 140 and a second layer 150, which is formed upon a surface 142 of the first layer 140. Here, the second layer 150 is an outermost layer or external layer of the multi-layer film, and comprises at least the halo active aromatic sulfonamide compound 145 dispersed throughout the primary coating additive. The first and second layers 140, 150 may independently have a thickness 155t, 160t, respectively, of from about 50 μm to about 5 mm, including from about 100 μm to about 200 μm, or from about 200 μm to about 300 μm, or from about 300 μm to about 400 μm, or from about 400 μm to about 500 μm, or from about 500 μm to about 600 μm, or from about 600 μm to about 700 μm, or from about 700 μm to about 800 μm, or from about 800 μm to about 900 μm, or from about 900 μm to about 1 mm, or from about 1 mm to about 2 mm, or from about 2 mm to about 3 mm, or from about 3 mm to about 4 mm, or from about 4 mm to about 5 mm, or any combination of endpoints thereof.

Turning to FIG. 1C, a third exemplary embodiment of a coating film 165 formed on a substrate 170 is illustrated. As shown, a portion 100C of the substrate 170 has a multi-layer film 165 formed upon a surface 172 of the substrate 170, the multi-layer film including a first layer 175 and a second layer 180 formed upon a surface 177 of the first layer 175. The layers can be formed by application of a single coating composition which then separates to form the layers, or by application of multiple coating compositions (one for each layer). Here, the first layer 175 is an internal layer of the multi-layer film, and comprises at least the halo active aromatic sulfonamide compound 185 dispersed throughout the primary coating additive. Again depending on the coating additive used, the first and second layers 175, 180 may independently have a thickness 190t, 195t, respectively, of from 0.33 nanometers to 1 cm, or from about 50 μm to about 5 mm, including from about 100 μm to about 200 μm, or from about 200 μm to about 300 μm, or from about 300 μm to about 400 μm, or from about 400 μm to about 500 μm, or from about 500 μm to about 600 μm, or from about 600 μm to about 700 μm, or from about 700 μm to about 800 μm, or from about 800 μm to about 900 μm, or from about 900 μm to about 1 mm, or from about 1 mm to about 2 mm, or from about 2 mm to about 3 mm, or from about 3 mm to about 4 mm, or from about 4 mm to about 5 mm, or up to 1 cm, or any combination of endpoints thereof.

It is contemplated that the second layer 180 is permeable or semi-permeable. As a result, various microorganisms and/or malodorous compounds on the external surface of the substrate 170 (and the coating film 165) can migrate inwards to the internal layer containing the halo active aromatic sulfonamide compound 185 and be neutralized. It is also possible for the halo active aromatic sulfonamide compound to migrate from the internal layer to the external surface due to humidity.

In some embodiments, the substrate 110, 135, 170 may include or comprise a hard surface, such as glass, metal, plastic, plastic, ceramic, concrete, stone, wood, and the like. In others, the substrate may include or comprise a soft surface, such as textiles, rugs, carpet, drapes, sponges, furniture, currency, paper, and the like. The film 105, 130, 165 or a layer thereof may be formed from the coating composition containing a halo active aromatic sulfonamide compound as described herein, and can maintain antimicrobial properties for an extended period of time after application of the coating composition and formation of the coating film.

In additional applications, it is contemplated that the coating compositions of the present disclosure can be used to form a coating film for food packaging, as such a film has both antimicrobial action and odor reducing properties.

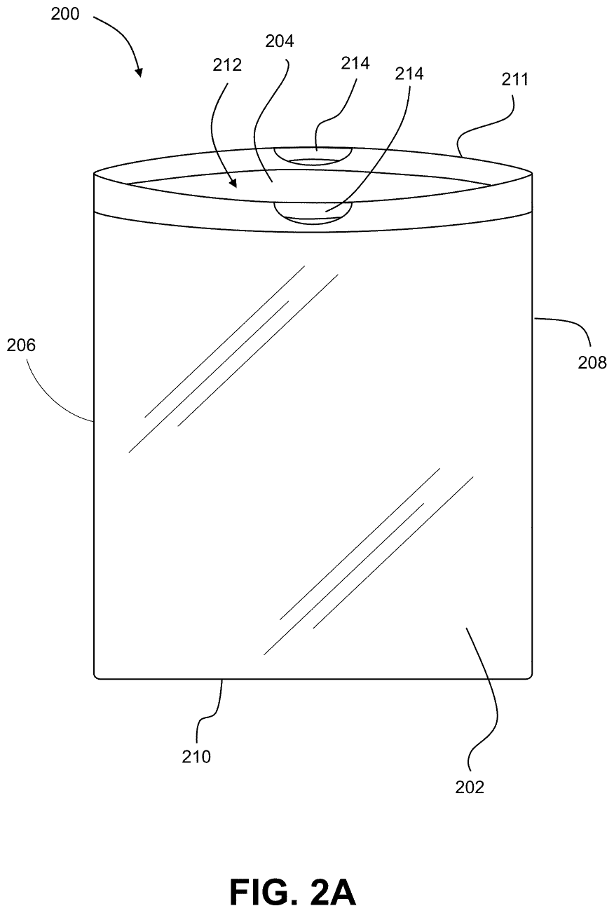

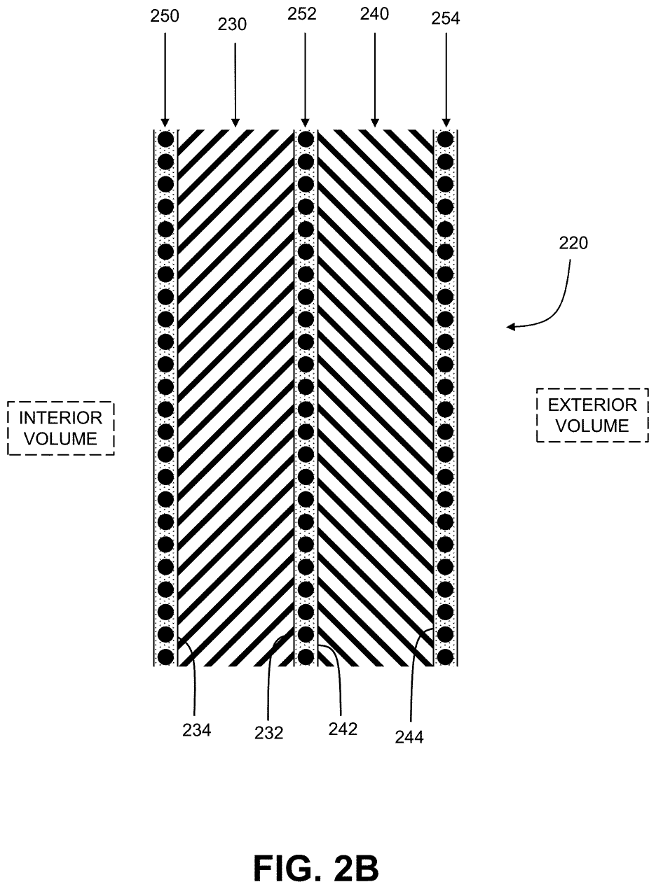

With reference to FIG. 2A, it is contemplated that the substrate is a bag, such as a polymeric trash bag. In FIG. 2A, a perspective view of a multi-layer trash bag 200 is illustrated. The trash bag 200 includes a first sidewall 202 and a second sidewall 204. The two sidewalls 202, 204 are joined together along a first side edge 206, a second side edge 208 opposite the first side edge, and a bottom edge 210 extending between the first and second side edges 206, 208. The bag has a top edge 211 opposite the bottom edge which is not sealed, and when the bag is expanded, an opening 212 is formed through which items are thrown into the internal volume of the trash bag. The sealed edges 206, 208, 210 can be made by, for example, heat sealing two separate multi-layer films together along all three edges 206, 208, 210. Alternatively, a single large multi-layer film could be folded in half (the fold line corresponding to bottom edge 210) and the two side edges could be sealed together. Along the top edge 211 is a draw tape 214 that acts as a closure mechanism for the trash bag, and which is visible through apertures along the top edge.

Turning to FIG. 2B, illustrated is a cross-sectional view of one of the sidewalls of the trash bag of FIG. 2A. As previously mentioned, the sidewall 220 is formed from a multi-layer film. Here, the sidewall 220 is illustrated as having a first film layer 230 and a second film layer 240 (of course, the multi-layer film can contain additional layers). The first film layer 230 has an interior surface 232 and an exterior surface 234. The second film layer 240 also has an interior surface 242 and an exterior surface 244. The interior surfaces 232, 242 of the two film layers face each other and are laminated together. The exterior surface 234 of the first film layer faces the internal volume of the trash bag, while the exterior surface 244 of the second film layer also forms the outer surface of the trash bag itself. The two film layers may have thicknesses as desired. The first film layer 230 may be relatively permeable to gases and liquids.

It is contemplated that the coating film could be located in multiple locations. First, the coating film could be located on the exterior surface 234 of the first film layer, or in other words on the inner surface of the trash bag (indicated with reference numeral 250). Second, the coating film could be located on one of the interior surfaces 232, 242 of the film layers, or in other words between the two film layers 230, 240 of the trash bag (indicated with reference numeral 252). Third, the coating film could be located on the exterior surface 244 of the second film layer, or in other words on the outer surface of the trash bag (indicated with reference numeral 254). The coating film may be uniformly formed across the entire film layer, or preferentially formed in desired locations such as along the top edge/opening of the trash bag. The coating film may be formed at any one or combination of these locations. In whatever location, it is contemplated the coating film containing the halo active aromatic sulfonamide compound can be exposed to water/moisture (e.g. permeating through the film layer) that hydrates the sulfonamide compound and permits its active antimicrobial and odor control ability. Water may also be present via the hydrated sulfonamide compound itself.

While not being limited by theory, it is believed that minor amounts of water, either through the hydrated nature active sulfonamide compound and/or the ambient humidity, will keep the sulfonamide active over an extended period of time compared to other products such as bleach. Thus, the antimicrobial kill performance and/or odor-eliminating performance of the sulfonamide will extend over that time period as well, so that new applications of microorganisms or odor-causing molecules will also be eliminated, even after drying. Extended kill and prophylactic protection of surfaces is thus possible for times of up to 2 weeks, one month, multiple months, or one year, or even multiple years as previously described herein, as long as the sulfonamide compound is not exhausted or decomposed or degraded. Such performance is not obtained by other disinfectants such as bleach, even when they are rewetted. Put another way, known products (bleach, peroxide) generally only kill microorganisms while they are wet, and their killing ability essentially ends after they have dried. Such products provide little, if any, residual protection: if new microorganisms are applied to the surface after the product has dried, those new microorganisms will survive and reproduce. This lack of residual protection by known products is substantially different from the compositions presently disclosed herein.

As described herein, the coating and/or adhesive films formed by the coating/adhesive compositions can be effective to achieve extended kill and prophylactic protection of surface, including with respect to a variety of microorganisms, including, for example, Staphylococcus aureus (i.e. S. aureus), Pseudomonas aeruginosa (i.e. P. aeruginosa), and Clostridium difficile (i.e. C. difficile).

Coating Methods

Also disclosed herein are methods and processes for applying the coating compositions comprising the halo active aromatic sulfonamide compounds described above to a substrate. That is, methods of treating one or more surfaces of a substrate to provide an antimicrobial and odor-controlling coating film to the substrate are disclosed. In accordance with several aspects of the methods described, the treated surface may maintain antimicrobial effect and/or odor-controlling ability for over 24 hours, or over 48 hours, or over 72 hours, or over 168 hours, or over 336 hours, or longer.

The coating films formed from the coating compositions of the present disclosure may achieve high microbial killing performance over extended periods of time. In particular embodiments, the coating films can maintain a killing performance after drying or curing (i.e., in residual dry-coat form) of at least 85% after 24 hours, or at least 90% after 24 hours, or at least 95% after 24 hours, or at least 98% after 24 hours, or at least 85% after 48 hours, or at least 90% after 48 hours, or at least 95% after 48 hours, or at least 98% after 48 hours, or at least 85% after 72 hours, or at least 90% after 72 hours, or at least 95% after 72 hours, or at least 98% after 72 hours, or at least 85% after 168 hours, or at least 90% after 168 hours, or at least 95% after 168 hours, or at least 98% after 168 hours, or at least 85% after 336 hours, or at least 90% after 336 hours, or at least 95% after 336 hours, or at least 98% after 336 hours.

The methods of treating a surface of a substrate to form an antimicrobial and odor-controlling coating film on the substrate generally comprise the steps of: preparing a coating composition comprising a halo active aromatic sulfonamide compound; applying the coating composition to a substrate; and forming a coating film on the substrate from the coating composition.

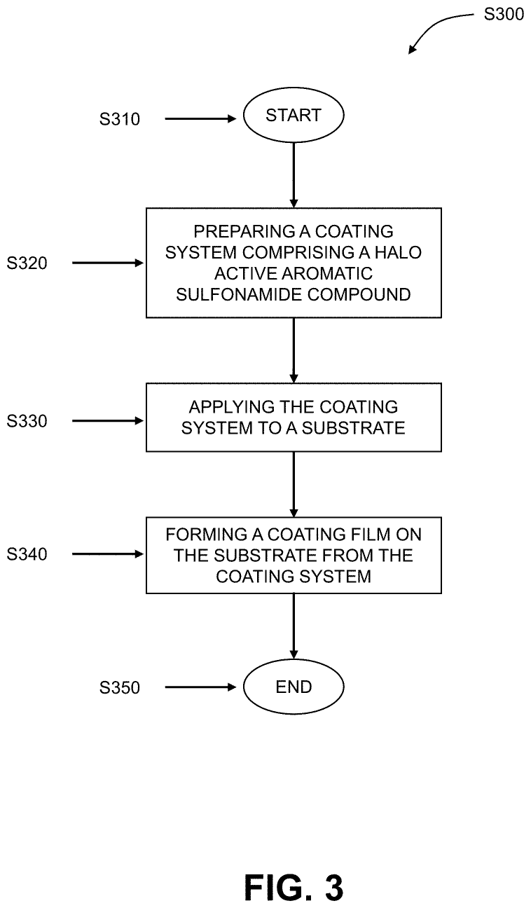

With reference to FIG. 3, one exemplary method S300 is illustrated. The method S300 begins at S310. The method S300 includes the steps of: preparing a coating composition comprising a halo active aromatic sulfonamide compound (S320); applying the coating composition to a substrate (S330); and forming a coating film on the substrate from the coating composition (S340). The coating composition may be variously embodied as described above, for example, as comprising an active composition, a film-forming composition, and at least one solvent.

In step S320, the coating composition comprising a halo active aromatic sulfonamide compound is prepared. In particular embodiments, step S320 may involve mixing or otherwise combining the halo active aromatic sulfonamide compound with a primary coating additive and optionally secondary additives, as described above. In certain embodiments, step S320 involves dissolving the various ingredients in a solvent, and combining the mixture with at least the halo active aromatic sulfonamide compound to form a coating composition.

In step S330, the coating composition can be applied to one or more surfaces of a substrate by simple solution, spin coating, dip coating, contour coating, doctor blading, solution casting, extrusion/dispersion coating, spray coating, gravure coating, printing techniques such as screen printing, ink-jet printing and the like, electrostatic application, fogging, wipes, misting, or immersion, amongst other applications. In particular embodiments, the step S330 may include heating the coating composition or a portion thereof to a desirable temperature so that the coating composition is in a sufficiently liquid state to facilitate application to the substrate.

In step S340, a final coating film is formed on the substrate from the coating composition. In some embodiments, the coating film is formed by allowing the coating composition that was applied to the substrate in S330 to evaporate over a period of time. That is, after application of the coating composition in step S330, the solvent may be allowed to evaporate, thereby forming a coating film on the substrate. In particular embodiments, the step S340 may be performed at room temperature. In other embodiments, the step S340 may be performed at elevated temperatures, such as temperatures above room temperature, to increase the evaporation rate of the solvent. Vacuum can also be applied, if desired.

At step S350, the method ends.

The coating compositions of the present disclosure can protect a variety of hard or soft substrates, including but not limited to: automobiles, appliances, metals, stainless steel, leather, gypsum board and drywall, painted surfaces, toilets, sinks, faucets, countertops, bedrails, beds, linens, light switches, hospital and other touchpoint surfaces, remotes, keyboards, cellphones, phones, communication devices, walls, toys, cushions, electronic buttons such as in elevators, money and currency, exercise equipment, rehabilitation equipment, paper, upholstery, food preparation materials and equipment, food, and/or perishable produce. Hard surfaces can include those on desks, tables, chairs, beds, walls, windows, handles, floors, ceilings, toilets, sinks, electronic devices, handrails, etc. Soft surfaces can include those on plastics (i.e. polymers), window coverings (drapes, curtains, blinds, etc.), and the like. Generally, a hard surface is one that cannot be bent by a person with their unassisted bare hands, whereas a soft surface can be bent or is flexible to some degree.

The coating compositions disclosed herein may also be applied to a surface or surfaces of an article during the manufacturing of the article. For example, the coating composition may be impregnated into or otherwise applied to a surface of an article during the manufacturing process. More specifically, the coating composition can be impregnated into and/or otherwise applied to articles including but not limited to: gypsum board and drywall, personal items such as toothpaste or mouthwash, building materials for commercial, industrial, and residential industry, toys, money and currency, paper, ink, sports equipment, clothing, packaging materials, food and/or perishable produce, food preparation materials and equipment, and hard and soft surfaces.

In certain embodiments of the methods disclosed herein, the coating composition also acts as an adhesive. In such embodiments, the substrate may further be a carrier or backing for the adhesive film, which allows the adhesive film to be stored for later use while retaining its adhesive and antimicrobial/odor-reducing properties.

Adhesive Compositions

In accordance with certain aspects of the present disclosure, the coating compositions may also be considered an adhesive composition that is capable of forming an adhesive film comprising the halo active aromatic sulfonamide compound. That is, the coating compositions disclosed herein may be applied to surfaces of two separate substrates to bind them together and resist their separation. In such embodiments, the primary coating additive may be, for example, a primary resin which imparts adhesion strength to the adhesive composition.

In particular embodiments, the primary coating additive (B) of such adhesive compositions may include an anaerobic adhesive, an elastic adhesive, a conductive adhesive, a flame-retardant adhesive, a damping adhesive, a quick-drying glue, a UV-curable adhesive, an electron beam curable adhesive, a visible light curable adhesive, a hotmelt adhesive, a medical adhesive, a shoe adhesive, and/or a structural adhesive.

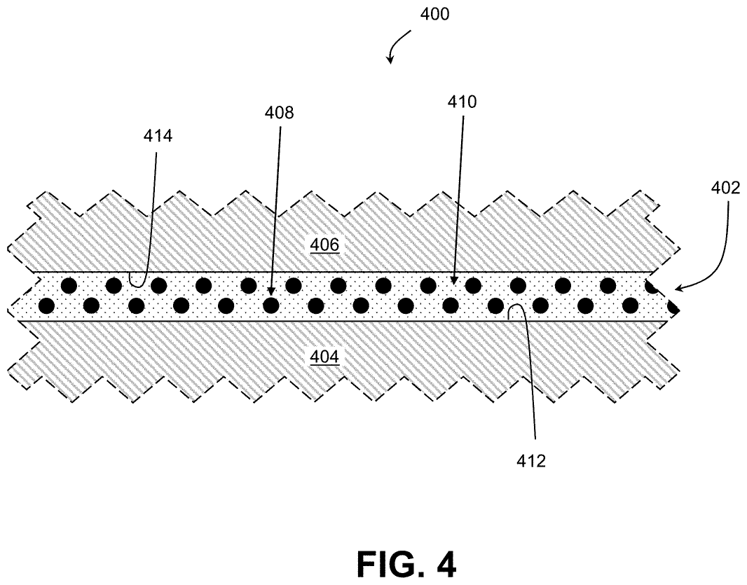

With reference to FIG. 4, one exemplary embodiment of a coating film that is also an adhesive film, formed from an adhesive composition, is illustrated. In particular, shown is a portion 400 of two substrates 404, 406, which are bound together using an adhesive film 402. More specifically, the adhesive film 402 binds a surface 412 of a first substrate 404 to a surface 414 of a second substrate 406.

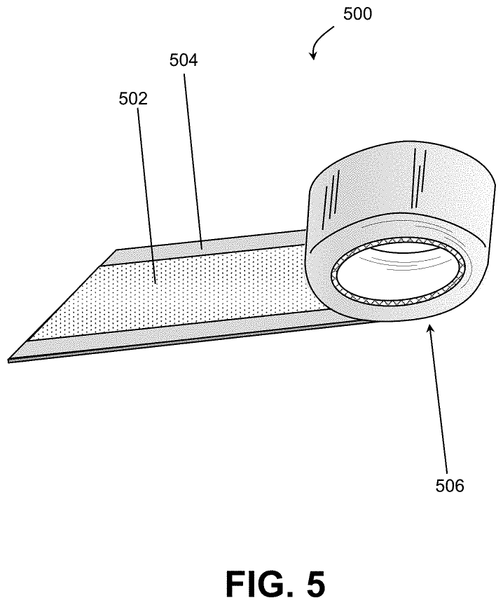

With reference to FIG. 5, the adhesive composition 502 comprising at least a halo active aromatic sulfonamide compound may be prepared on a carrier substrate 504, which may later be used to apply the adhesive composition 502 to one or more substrates. That is, also disclosed herein, are articles 500 comprising a carrier 504 (i.e. substrate) and an adhesive film 502 formed thereupon from a coating composition in accordance with the present disclosure. In particular embodiments, the article 500 may be, for example, a roll of tape 506.

The adhesive films formed from the adhesive compositions of the present disclosure may achieve high microbial killing and/or odor-reducing performance over extended periods of time. In particular embodiments, the adhesive films can maintain a killing performance of at least 85% after 24 hours, or at least 90% after 24 hours, or at least 95% after 24 hours, or at least 98% after 24 hours, or at least 85% after 48 hours, or at least 90% after 48 hours, or at least 95% after 48 hours, or at least 98% after 48 hours, or at least 85% after 72 hours, or at least 90% after 72 hours, or at least 95% after 72 hours, or at least 98% after 72 hours, or at least 85% after 168 hours, or at least 90% after 168 hours, or at least 95% after 168 hours, or at least 98% after 168 hours, or at least 85% after 336 hours, or at least 90% after 336 hours, or at least 95% after 336 hours, or at least 98% after 336 hours.

The following examples are provided to illustrate the compositions, films, methods, articles, and properties of the present disclosure. The examples are merely illustrative and are not intended to limit the disclosure to the materials, conditions, or process parameters set forth therein.

### EXAMPLES

### Example 1

A solution was made that contained about 2 wt % N-chloro-4-carboxybenzenesulfonamide compound (BENZ), 98 wt % water, and sodium bicarbonate as a pH buffer. The solution was mixed with an acrylic (ACR) coating to form a coating composition. The coating composition was applied to a glass surface, then allowed to dry to form a coating film.

The coating film was then artificially aged for 150 hours at 55° C. This simulated a passage of time of over six months. The stability of the BENZ was then tested.

An organic indicator was then applied to the coating film. The organic indicator contained a compound that reacts with the BENZ, and represents an organic substance. The organic indicator began changing color, with the intensity of the orange color corresponding to the total amount of the organic substance reacting with the BENZ. When the color ceased changing, this represented the total eradication of the organic substance.

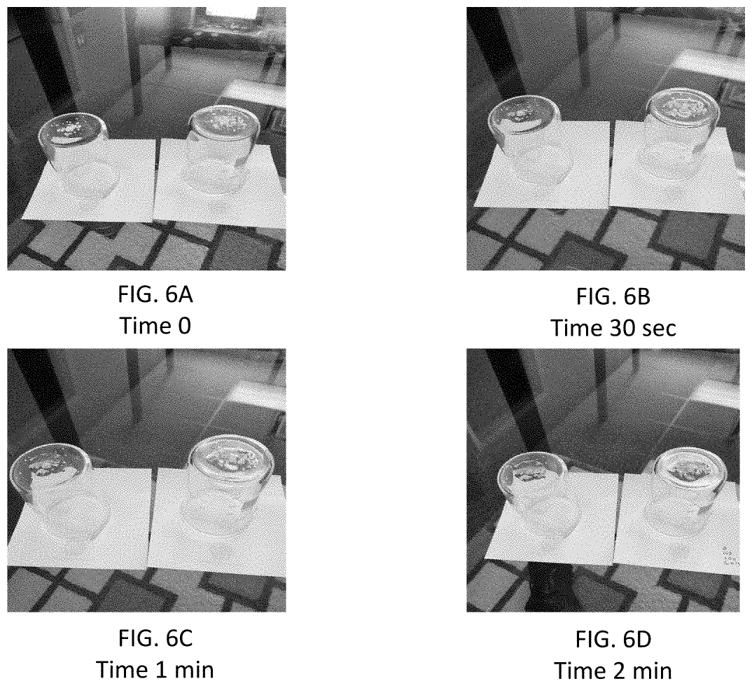

The ACR coating containing the BENZ molecule completely reacted with the organic substance in about two minutes. FIGS. 6A-6D are pictures from time zero through two minutes after exposure to the organic substance.

The completely reacted organic indicator was removed from the coating, and new organic indicator was applied. The new organic indicator also changed color, indicating that the BENZ was not completely used up after the first application.

### Example 2

The solution containing 2 wt % BENZ was made as in Example 1. The solution was mixed with a styrene-butadiene polymer (SBD) to form a coating composition. The coating composition was applied to a glass surface, then allowed to dry to form a coating film. The coating film was then artificially aged for 150 hours at 55° C. The stability of the BENZ was then tested.

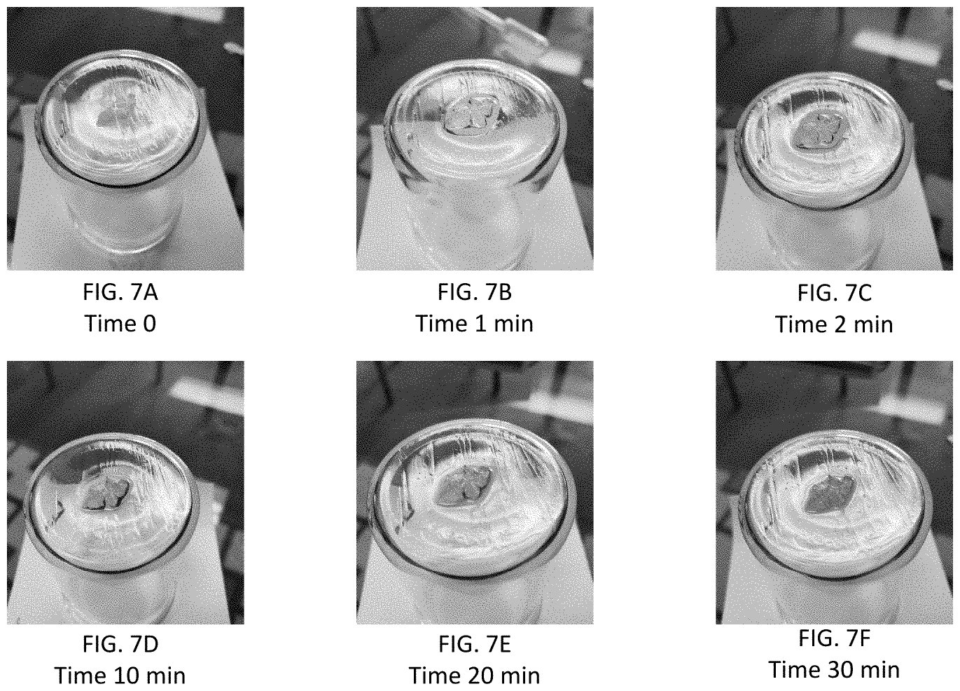

An organic indicator was then applied to the coating film as in Example 1. The SBD coating containing the BENZ molecule completely reacted with the organic substance in about 30 minutes. FIGS. 7A-7F are pictures from time zero through 30 minutes after exposure to the organic substance.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. An antimicrobial and odor-reducing coating composition, comprising:
a halo active aromatic sulfonamide compound of Formula (I): 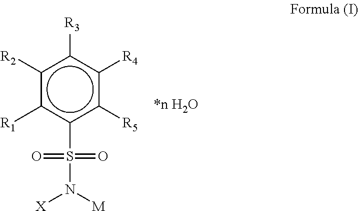
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;
R′ is hydrogen, an alkali metal, an alkaline earth metal, substituted C₁-C₁₈ alkyl, or unsubstituted C₁-C₁₈ alkyl; and
R″ is hydrogen or substituted or unsubstituted C₁-C₁₈ alkyl, where the two R″ groups in CON(R″)₂ and N(R″)₂ may be independently selected from each other;
X is halogen;
M is an alkali or alkaline earth metal; and
n is the number of water molecules per molecule of the sulfonamide compound;
a primary coating additive; and
a solvent.

2. The coating composition of claim 1, wherein at least one of R₁, R₂, R₃, R₄, or R₅ is not hydrogen.

3. The coating composition of claim 1, wherein the halo active aromatic sulfonamide compound is chloramine-T or N-chloro-4-carboxybenzenesulfonamide.

4. The coating composition of claim 1, wherein the solvent comprises water.

5. The coating composition of claim 1, wherein the primary coating additive comprises a polyolefin, a polyvinyl compound, a polyacrylic resin, or a cellulose or cellulose derivative.

6. The coating composition of claim 5, wherein the primary coating additive comprises styrene butadiene, an acrylic, vinyl acetate, or hydroxypropyl methylcellulose (HPMC).

7. The coating composition of claim 1, wherein the halo active aromatic sulfonamide compound is present in the coating composition in an amount of about 0.0001 wt % to about 40 wt %, based on the weight of the coating composition; or
wherein the primary coating additive is present in the coating composition in an amount of about 0.001 wt % to about 99.99 wt %, based on the weight of the coating composition.

8. The coating composition of claim 1, wherein the solvent comprises the balance of the coating composition; or
wherein the solvent is present in the coating composition in an amount of about 20 wt % to about 99.9 wt %.

9. The coating composition of claim 1, further comprising a buffering agent;
optionally wherein the buffering agent is present in a quantity sufficient to obtain a pH of about 6 to about 14 for the coating composition; or
wherein the buffering agent is present in a quantity sufficient to obtain a pH of about 6 to about 10 for the composition.

10. The coating composition of claim 1, further comprising a surfactant; a tracer fragrance; an UV indicator; or a secondary additive;
wherein the secondary additive comprises a pigment, an antioxidant, a filler, a plasticizer, a reinforcing agent, a thickener, an antifungal agent, an emulsifier, a thixotropic agent, an antimicrobial agent, or a conductive material.

11. The coating composition of claim 1, wherein the halo active aromatic sulfonamide compound is present in the composition in an amount of about 0.0001 wt % to about 40 wt %.

12. A coating film comprising a halo active aromatic sulfonamide compound of Formula (I): 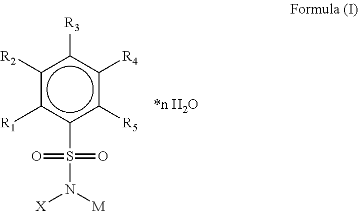
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;
R′ is hydrogen, an alkali metal, an alkaline earth metal, substituted C₁-C₁₈ alkyl, or unsubstituted C₁-C₁₈ alkyl; and
R″ is hydrogen or substituted or unsubstituted C₁-C₁₈ alkyl, where the two R″ groups in CON(R″)₂ and N(R″)₂ may be independently selected;
X is halogen;
M is an alkali or alkaline earth metal; and
n is the number of water molecules per molecule of the sulfonamide compound.

13. The coating film of claim 12, wherein the halo active aromatic sulfonamide compound is present in the coating film in an amount of about 0.0001 wt % to about 99.99 wt %, based on the weight of the coating film; or
wherein the coating film maintains at least 98% killing performance after 168 hours.

14. The coating film of claim 12, wherein the coating film is also an adhesive film.

15. An article having an antimicrobial and/or odor-reducing coating film on a surface thereof, the coating film comprising a halo active aromatic sulfonamide compound of Formula (I): 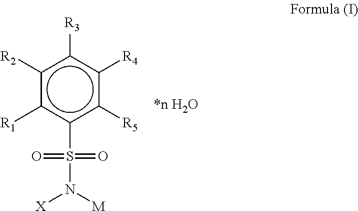
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;
R′ is hydrogen, an alkali metal, an alkaline earth metal, substituted C₁-C₁₈ alkyl, or unsubstituted C₁-C₁₈ alkyl; and
R″ is hydrogen or substituted or unsubstituted C₁-C₁₈ alkyl, where the two R″ groups in CON(R″)₂ and N(R″)₂ may be independently selected;
X is halogen;
M is an alkali or alkaline earth metal; and
n is the number of water molecules per molecule of the sulfonamide compound.

16. The article of claim 15, wherein the article is a trash bag.

17. The article of claim 16, wherein (A) the coating film is on an inner surface of the trash bag or an outer surface of the trash bag, or (B) the trash bag is formed from a multi-layer film and the coating film is located between two layers of the film.

18. A method of treating a surface of a substrate to form an antimicrobial and odor-reducing coating film thereon, the method comprising:
preparing a coating composition comprising a halo active aromatic sulfonamide compound, a primary coating additive, and a solvent;
applying the coating composition to the surface of the substrate; and
forming a coating film on the surface of the substrate from the coating composition;
wherein the halo active aromatic sulfonamide compound has the structure of Formula (I): 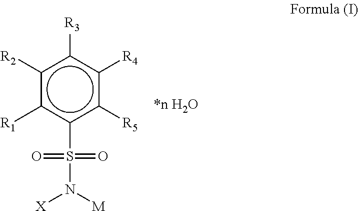
wherein R₁, R₂, R₃, R₄, and R₅ are independently selected from hydrogen, COOR′, CON(R″)₂, alkoxy, CN, NO₂, SO₃R″, halogen, substituted or unsubstituted phenyl, sulfonamide, halosulfonamide, N(R″)₂, substituted or unsubstituted C₁-C₁₈ alkyl, and substituted or unsubstituted aromatic;
R′ is hydrogen, an alkali metal, an alkaline earth metal, substituted C₁-C₁₈ alkyl, or unsubstituted C₁-C₁₈ alkyl; and
R″ is hydrogen or substituted or unsubstituted C₁-C₁₈ alkyl, where the two R″ groups in CON(R″)₂ and N(R″)₂ may be independently selected;
X is halogen;
M is an alkali or alkaline earth metal; and
n is the number of water molecules per molecule of the sulfonamide compound;

19. The method of claim 18, wherein the halo active aromatic sulfonamide compound is N-chloro-4-carboxybenzenesulfonamide; or
wherein the composition is applied to the surface by simple solution, spin coating, dip coating, contour coating, doctor blading, solution casting, extrusion/dispersion coating, spray coating, gravure coating, screen printing, ink-jet printing, electrostatic application, fogging, wipes, misting, or immersion.

20. The method of claim 18, wherein the composition maintains at least 98% killing performance after 168 hours; or
wherein the coating film is formed by evaporation of the solvent from the coating composition.
